(19) United States
(12) Patent Application Publication
(10) Pub. No.: US 2023/0256469 A1
(43) Pub. Date: Aug. 17, 2023

(54) SUBSTRATE WITH WATER AND OIL REPELLENT LAYER, AND METHOD FOR PRODUCING SUBSTRATE WITH WATER AND OIL REPELLENT LAYER

(71) Applicant: AGC INC., Tokyo (JP)

(72) Inventors: Ryuta TAKASHITA, Tokyo (JP); Toyokazu ENTA, Tokyo (JP)

(73) Assignee: AGC INC., Tokyo (JP)

(21) Appl. No.: 18/104,853

(22) Filed: Feb. 2, 2023

Related U.S. Application Data
(63) Continuation of application No. PCT/JP2021/033352, filed on Sep. 10, 2021.

(30) Foreign Application Priority Data
Sep. 16, 2020 (JP) 2020-155248

(51) Int. Cl. B05D 5/08; B05D 1/00; B05D 7/00

(52) U.S. Cl. CPC B05D 5/086; B05D 1/60; B05D 7/5483; B05D 2203/35; B05D 2506/10; B05D 2350/60; B05D 2401/33

(57) ABSTRACT

A substrate with a water and oil repellent layer having excellent abrasion resistance and a method for producing the substrate are provided. The substrate with a water and oil repellent layer contains a substrate, an undercoat layer formed on the surface of the substrate, and a water and oil repellent layer formed on the surface of the undercoat layer. The undercoat layer contains an oxide containing silicon and a specific element. The water and oil repellent layer is made of a hydrolytic condensation compound of a fluorinated ether compound, which is a compound represented by the formula (A1) or a compound represented by the formula (A2):

R^{f}—O—(R^{f1}O)ₘ—R^{f2}[—R¹—C(—R²-T)ₐ(—R³)₃₋ₐ]_{b} (A1)

[(T-R²—)ₐ(R³—)₃₋ₐC—R¹—]_{b}R^{f2}—O—(R^{f1}O)ₘ—R^{f2}[—R¹—C(—R²-T)ₐ(—R³)₃₋ₐ]_{b} (A2).

### TECHNICAL FIELD

The present invention relates to a substrate with a water and oil repellent layer and a method for producing a substrate with a water and oil repellent layer.

### BACKGROUND ART

It is known to form a water and oil repellent layer made of a hydrolytic condensation product of a fluorinated compound on the surface of a substrate by surface treatment using a silane compound containing a perfluoro(poly)ether group in order to impart water and oil repellency, fingerprint stain removability, lubricity (smoothness when touched with fingers), etc. to the surface of the substrate (see Patent Document 1).

### PRIOR ART DOCUMENT

### Patent Document

Patent Document 1: WO2017/022437

### DISCLOSURE OF INVENTION

### Technical Problem

In recent years, the performance requirements for a water and oil repellent layer have become higher, and a water and oil repellent layer with superior water and oil repellency and abrasion resistance is required.

The water and oil repellent layer formed by using a silane compound containing a perfluoro(poly)ether group as described in Patent Document 1 was insufficient in abrasion resistance.

The present invention was made in view of the above problems and has an object to provide a substrate with a water and oil repellent layer excellent in abrasion resistance and a method for producing a substrate with a water and oil repellent layer.

### Solution to Problem

The present invention provides the following [1] to [12].

[1] A substrate with a water and oil repellent layer comprising

a substrate,

an undercoat layer formed on the surface of the substrate, and

a water and oil repellent layer formed on the surface of the undercoat layer, wherein

the undercoat layer contains an oxide containing silicon and at least one specific element selected from the group consisting of Group 1 elements, Group 2 elements, Group 4 elements, Group 5 elements, Group 13 elements and Group 15 elements of the periodic table, and

the water and oil repellent layer is made of a hydrolytic condensation product of a fluorinated ether compound selected from the group consisting of a compound represented by the formula (A1) and a compound represented by the formula (A2):

R^{f}—O—(R^{f1}O)ₘ—R^{f2}[—R¹—C(—R²-T)ₐ(—R³)₃₋ₐ]_{b} (A1)

[(T-R²—)ₐ(R³—)₃₋ₐC—R¹—]_{b}R^{f2}—O—(R^{f1}O)ₘ—R^{f2}[—R¹—C(—R²-T)^{a}(—R³)₃₋ₐ]_{b} (A2)

where

R^{f} is a C₁₋₂₀ fluoroalkyl group,

R^{f1} is a C₁₋₆ fluoroalkylene group,

R^{f2} is a (1+b)-valent hydrocarbon group having fluorine atom(s), at least one carbon atom bonded to R¹ has fluorine atom(s), and if a plurality of R^{f2} are present, the plurality of R^{f2} may be the same or different,

R¹ is a C₁₋₂₀ alkylene group,

R² is a C₂₋₂₀ alkylene group which may have fluorine atom(s), and the plurality of R² may be the same or different,

R³ is a hydrogen atom or a C₁₋₁₀ alkyl group which may have fluorine atom(s), and if a plurality of R³ are present, the plurality of R³ may be the same or different,

T is —Si(R)_{3-c}(L)_{c}, and the plurality of T may be the same or different,

R is an alkyl group,

L is a hydrolyzable group or a hydroxy group, and two or more L in T may be the same or different,

m is an integer of from 1 to 20,

a is an integer of from 1 to 3, and if a plurality of a are present, the plurality of a may be the same or different,

b is an integer of 1 or more, and if a plurality of b are present, the plurality of b may be the same or different,

c is 2 or 3, and the plurality of c may be the same or different, and

if b is 1, a is 2 or 3.

[2] The substrate with a water and oil repellent layer according to [1], wherein R^{f2} is a hydrocarbon group having b substructures “-CQF-* (where Q is a hydrogen atom, a fluorine atom or CF₃, and -* is a bonding hand to be bonded to R¹)”.
[3] The substrate with a water and oil repellent layer according to [1] or [2], wherein b is 1, and R^{f2} is a C₁₋₆ perfluoroalkylene group.
[4] The substrate with a water and oil repellent layer according to any one of [1] to [3], wherein the specific element is at least one selected from the group consisting of Group 1 elements, Group 2 elements and Group 13 elements of the periodic table.
[5] The substrate with a water and oil repellent layer according to any one of [1] to [4], wherein the specific element is a Group 1 element of the periodic table.
[6] The substrate with a water and oil repellent layer according to any one of [1] to [5], wherein b is 1.
[7] The substrate with a water and oil repellent layer according to any one of [1] to [6], wherein a is 3.
[8] The substrate with a water and oil repellent layer according to any one of [1] to [7], wherein the ratio of the total molar concentration of the specific element to the molar concentration of silicon in the undercoat layer is from 0.02 to 2.90.
[9] A method for producing a substrate with a water and oil repellent layer, having a substrate, an undercoat layer and a water and oil repellent layer in this order, which comprises

forming, on said substrate, an undercoat layer containing an oxide containing silicon and at least one specific element selected from the group consisting of Group 1 elements, Group 2 elements, Group 4 elements, Group 5 elements, Group 13 elements and Group 15 elements of the periodic table, and

then, forming, on the undercoat layer, a water and oil repellent layer made of a hydrolytic condensation product of a fluorinated ether compound selected from the group consisting of a compound represented by the formula (A1) and a compound represented by the formula (A2):

R^{f}—O—(R^{f1}O)ₘ—R^{f2}[—R¹—C(—R²-T)ₐ(—R³)₃₋ₐ]_{b} (A1)

[(T-R²—)ₐ(R³—)₃₋ₐC—R¹—]_{b}R^{f2}—O—(R^{f1}O)ₘR—^{f2}[R¹—C(—R²-T)ₐ(—R³)₃₋ₐ]_{b} (A2)

where

R^{f} is a C₁₋₂₀ fluoroalkyl group,

R^{f1} is a C₁₋₆ fluoroalkylene group,

R^{f2} is a (1+b)-valent hydrocarbon group having fluorine atom(s), at least one carbon atom bonded to R¹ has fluorine atom(s), and if a plurality of R^{f2} are present, the plurality of R^{f2} may be the same or different,

R¹ is a C₁₋₂₀ alkylene group,

R² is a C₂₋₂₀ alkylene group which may have fluorine atom(s), and the plurality of R² may be the same or different,

R³ is a hydrogen atom or a C₁₋₁₀ alkyl group which may have fluorine atom(s), and if a plurality of R³ are present, the plurality of R³ may be the same or different,

T is —Si(R)_{3-c}(L)_{c}, and the plurality of T may be the same or different,

R is an alkyl group,

L is a hydrolyzable group or a hydroxy group, and two or more L in T may be the same or different,

m is an integer of from 1 to 20,

a is an integer of from 1 to 3, and if a plurality of a are present, the plurality of a may be the same or different,

b is an integer of 1 or more, and if a plurality of b are present, the plurality of b may be the same or different,

c is 2 or 3, and the plurality of c may be the same or different, and

if b is 1, a is 2 or 3.

[10] The method for producing a substrate with a water and oil repellent layer according to [9], wherein R^{f2} is a hydrocarbon group having b substructures “-CQF-* (where Q is a hydrogen atom, a fluorine atom or CF₃, and -* is a bonding hand to be bonded to R¹)”.
[11] The method for producing a substrate with a water and oil repellent layer according to [9] or [10], wherein b is 1, and R^{f2} is a C₁₋₆ perfluoroalkylene group.
[12] The substrate with a water and oil repellent layer according to any one of [1] to [8], which is to be used as an optical member.

### Advantageous Effects of Invention

According to the present invention, it is possible to provide a substrate with a water and oil repellent layer excellent in abrasion resistance and a method for producing a substrate with a water and oil repellent layer.

### BRIEF DESCRIPTION OF DRAWINGS

FIG. 1 is a cross-sectional view schematically showing an example of the substrate with a water and oil repellent layer of the present invention.

### DESCRIPTION OF EMBODIMENTS

In this specification, a compound represented by the formula (A1) is referred to as compound (A1). Compounds, etc. represented by other formulae are also referred to in the same manner.

The meanings of the following terms in this specification are as follows.

A “reactive silyl group” is a generic term for a hydrolyzable silyl group and a silanol group (Si—OH). A reactive silyl group is, for example, T in the formula (A1) or the formula (A2), i.e. —Si(R)_{3-c}(L)_{c}.

A “hydrolyzable silyl group” means a group capable of forming a silanol group by hydrolysis reaction.

In a case where the fluorinated ether compound is a mixture of a plurality of fluorinated ether compounds with different chain lengths of polyfluoropolyether chains, the “molecular weight” of the polyfluoropolyether chain is the number-average molecular weight calculated by obtaining the number of oxyfluoroalkylene units (average value) based on the terminal group, by ¹H-NMR and ¹⁹F-NMR. The terminal group is, for example, R^{f} in the formula (A1) or T in the formula (A1) or the formula (A2).

In a case where the fluorinated ether compound is a fluorinated ether compound with a single chain length of polyfluoropolyether chain, the “molecular weight” of the polyfluoropolyether chain is the molecular weight calculated by determining the structure of R^{f} by ¹H-NMR and ¹⁹F-NMR.

[Substrate with Water and Oil Repellent Layer]

The substrate with a water and oil repellent layer of the present invention comprises a substrate, an undercoat layer, and a water and oil repellent layer in this order.

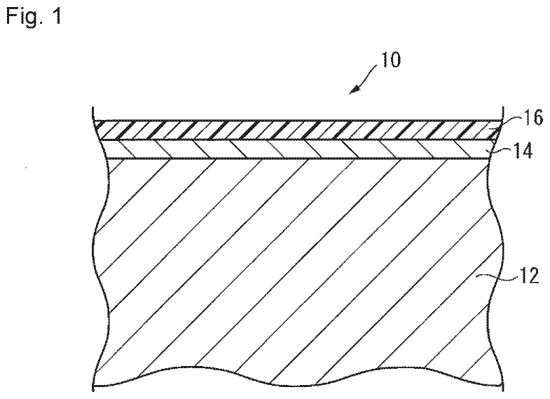

FIG. 1 is a schematic cross-sectional view of a substrate with a water and oil repellent layer of the present invention. The substrate 10 with a water and oil repellent layer comprises a substrate 12, an undercoat layer 14 formed on one surface of the substrate 12, and a water and oil repellent layer 16 formed on the surface of the undercoat layer 14.

In the example of FIG. 1, the substrate 12 and the undercoat layer 14 are in contact with each other, but not limited to this, the substrate with a water and oil repellent layer may have another layer not shown, between the substrate 12 and the undercoat layer 14. Further, in the example of FIG. 1, the undercoat layer 14 and the water and oil repellent layer 16 are in contact with each other, but the substrate with a water and oil repellent layer may have another layer not shown, between the undercoat layer 14 and the water and oil repellent layer 16.

In the example of FIG. 1, the undercoat layer 14 is formed on the entirety of one surface of the substrate 12, but not limited to this, the undercoat layer 14 may be formed on only a certain area of the substrate 12. Further, in the example of FIG. 1, the water and oil repellent layer 16 is formed on the entire surface of the undercoat layer 14, but not limited to this, the water and oil repellent layer 16 may be formed on only in a certain area of the undercoat layer 14.

In the example of FIG. 1, the undercoat layer 14 and the water and oil repellent layer 16 are formed on only one side of the substrate 12, but not limited to this, the undercoat layer 14 and water and oil repellent layer 16 may be formed on both sides of the substrate 12.

### (Substrate)

The substrate is not particularly limited so long as it is a substrate required to have water and oil repellency imparted. Specific examples of the material for the substrate include metal, resin, glass, sapphire, ceramic, stone and a composites of these materials. The glass may be chemically strengthened.

As the substrate, a substrate for a touch panel or a substrate for a display is preferred, and a substrate for a touch panel is particularly preferred. The substrate for a touch panel preferably has translucency. The term “having translucency” means that the transmittance of vertically-incident visible light in accordance with JIS R3106: 1998 (ISO 9050:1990) is 25% or more. As the material for the substrate for a touch panel, glass or transparent resin is preferred.

Further, as the substrate, the following examples may be mentioned. Glass or resin to be used for building materials, decorative building materials, interior goods, transportation equipment (e.g. automobiles), signs and billboards, drinking vessels and tableware, aquariums, ornamental equipment (e.g. frames, boxes), laboratory equipment, furniture, art, sports, and games; glass or resin to be used for exterior parts (excluding displays) in devices such as mobile phones (e.g. smartphones), mobile information terminals, game consoles, and remote controls. The shape of the substrate may be a plate or film.

The substrate may be a substrate having one or both surfaces treated with a surface treatment such as corona discharge treatment, plasma treatment or plasma graft polymerization treatment. The surface having surface treatment applied, is better in adhesion between the substrate and the undercoat layer, resulting in better abrasion resistance of the water and oil repellent layer. Therefore, it is preferred to apply the surface treatment to the surface on the side of the substrate in contact with the undercoat layer.

### (Undercoat Layer)

The undercoat layer is a layer containing an oxide containing silicon and at least one specific element selected from the group consisting of Group 1 elements, Group 2 elements, Group 4 elements, Group 5 elements, Group 13 elements and Group 15 elements of the periodic table.

Group 1 elements of the periodic table (hereinafter referred to also as “Group 1 elements”) mean lithium, sodium, potassium, rubidium and cesium. As Group 1 elements, lithium, sodium and potassium are preferred, and sodium and potassium are particularly preferred, from such a viewpoint that the water and oil repellent layer can be formed more uniformly on the undercoat layer without defects, or from such a viewpoint that variations in the composition of the undercoat layer among samples can be better suppressed. In the undercoat layer, two or more Group 1 elements may be contained.

Group 2 elements of the periodic table (hereinafter referred to also as “Group 2 elements”) mean beryllium, magnesium, calcium, strontium and barium. As Group 2 elements, magnesium, calcium and barium are preferred, and magnesium and calcium are particularly preferred, from such a viewpoint that the water and oil repellent layer can be formed more uniformly on the undercoat layer without defects, or from such a viewpoint that variations in the composition of the undercoat layer among samples can be better suppressed. In the undercoat layer, two or more Group 2 elements may be contained.

Group 4 elements of the periodic table (hereinafter referred to also as “Group 4 elements”) mean titanium, zirconium and hafnium. As Group 4 elements, titanium and zirconium are preferred, and titanium is particularly preferred, from such a viewpoint that the water and oil repellent layer can be formed more uniformly on the undercoat layer without defects, or from such a viewpoint that variations in the composition of the undercoat layer among samples can be better suppressed. In the undercoat layer, two or more Group 4 elements may be contained.

Group 5 elements of the periodic table (hereinafter referred to also as “Group 5 elements”) mean vanadium, niobium and tantalum. As a Group 5 element, vanadium is particularly preferred from such a viewpoint that the abrasion resistance of the water and oil repellent layer will be superior. In the undercoat layer, two or more Group 5 elements may be contained.

Group 13 elements of the periodic table (hereinafter referred to also as “Group 13 elements”) mean boron, aluminum, gallium and indium. As Group 13 elements, boron, aluminum and gallium are preferred, and boron and aluminum are particularly preferred, from such a viewpoint that the water and oil repellent layer can be formed more uniformly on the undercoat layer without defects, or from such a viewpoint that variations in the composition of the undercoat layer among samples can be better suppressed. In the undercoat layer, two or more Group 13 elements may be contained.

Group 15 elements of the periodic table (hereinafter referred to also as “Group 15 elements”) mean nitrogen, phosphorus, arsenic, antimony and bismuth. As Group 15 elements, phosphorus, antimony and bismuth are preferred, and phosphorus and bismuth are particularly preferred, from such a viewpoint that the water and oil repellent layer can be formed more uniformly on the undercoat layer without defects, or from such a viewpoint that variations in the composition of the undercoat layer among samples can be better suppressed. In the undercoat layer, two or more Group 15 elements may be contained.

As specific elements to be contained in the undercoat layer, Group 1 elements, Group 2 elements and Group 13 elements are preferred, because the abrasion resistance of the water and oil repellent layer will be superior, and Group 1 elements and Group 2 elements are more preferred, and Group 1 elements are particularly preferred.

As the specific element, only one type of element may be contained, or two or more types of elements may be contained.

The oxide to be contained in the undercoat layer may be a mixture of oxides of the above elements (silicon and a specific element) alone (e.g. a mixture of silicon oxide and an oxide of a specific element), may be a composite oxide containing two or more types of the above elements, or may be a mixture of the oxides of the above elements alone and the composite oxide.

The ratio of the total molar concentration of specific elements in the undercoat layer to the molar concentration of silicon in the undercoat layer (specific elements/silicon) is preferably from 0.02 to 2.90, more preferably from 0.10 to 2.00, particularly preferably from 0.20 to 1.80, from such a viewpoint that the abrasion resistance of the water and oil repellent layer will be superior.

The molar concentration (mol %) of each element in the undercoat layer can be measured, for example, by depth direction analysis by X-ray photoelectron spectroscopy (XPS) using ion sputtering.

The undercoat layer may be a single layer or multiple layers. The undercoat layer may have irregularities on the surface.

As the thickness of the undercoat layer, from 1 to 100 nm is preferred, from 1 to 50 nm is more preferred, and from 2 to 20 nm is particularly preferred. When the thickness of the undercoat layer is at least the above lower limit value, the adhesiveness of the water and oil repellent layer by the undercoat layer will be more improved, and the abrasion resistance of the water and oil repellent layer will be more excellent. When the thickness of the undercoat layer is at most the above upper limit value, the abrasion resistance of the undercoat layer itself will be excellent.

The thickness of the undercoat layer is measured by cross-sectional observation of the undercoat layer by a transmission electron microscope (TEM).

### (Water and Oil Repellent Layer)

The water and oil repellent layer is made of a hydrolytic condensation product of a fluorinated ether compound selected from the group consisting of compound (A1) and compound (A2).

The above fluorinated ether compound is a fluorinated compound having reactive silyl groups. That is, the water and oil repellent layer contains a condensed product in which some or all of the reactive silyl groups of the fluorinated compound have undergone hydrolysis reaction and dehydration-condensation reaction.

More specifically, the water and oil repellent layer may be composed of a hydrolytic condensation product of compound (A1), may be composed of a hydrolytic condensation product of compound (A2), or may be composed of both the hydrolytic condensation product of compound (A1) and the hydrolytic condensation product of compound (A2).

R^{f}—O—(R^{f1}O)ₘ—R^{f2}[—R¹—C(—R²-T)ₐ(—R³)₃₋ₐ]_{b} (A1)

[(T-R²—)ₐ(R³—)₃₋ₐC—R¹—]_{b}R^{f2}—O—(R^{f1}O)ₘ—R^{f2}[—R¹—C(—R²-T)ₐ(—R³)₃₋ₐ]_{b} (A2)

Here,

R^{f} is a C₁₋₂₀ fluoroalkyl group,

R^{f1} is a C₁₋₆ fluoroalkylene group,

R^{f2} is a (1+b)-valent hydrocarbon group having fluorine atom(s), at least one carbon atom bonded to R¹ has fluorine atom(s), and if a plurality of R^{f2} are present, the plurality of R^{f2} may be the same or different,

R¹ is a C₁₋₂₀ alkylene group,

R² is a C₂₋₂₀ alkylene group which may have fluorine atom(s), and the plurality of R² may be the same or different,

R³ is a hydrogen atom or a C₁₋₁₀ alkyl group which may have fluorine atom(s), and if a plurality of R³ are present, the plurality of R³ may be the same or different,

T is —Si(R)_{3-c}(L)_{c} and the plurality of T may be the same or different,

R is an alkyl group,

L is a hydrolyzable group or a hydroxy group, and two or more L in T may be the same or different,

m is an integer of from 1 to 20,

a is an integer of from 1 to 3, and if a plurality of a are present, the plurality of a may be the same or different,

b is an integer of 1 or more, and if a plurality of b are present, the plurality of b may be the same or different,

c is 2 or 3, and the plurality of c may be the same or different, and

if b is 1, a is 2 or 3.

Each of the above compounds (A1) and (A2) has a polyfluoropolyether chain [R^{f}—O—(R^{f1}O)ₘ-] or [—O—(R^{f1}O)ₘ—], a reactive silyl group and a specific linking group —R^{f2}[—R¹—C(—R²—)ₐ-]_{b} linking the polyfluoropolyether chain and the reactive silyl group.

Compound (A1) is a compound having the structure of “monovalent polyfluoropolyether chain-linking group-reactive silyl group”, and compound (A2) is a compound having the structure of “reactive silyl group-linking group-divalent polyfluoropolyether chain-linking group-reactive silyl group”.

In compounds (A1) and (A2), the above linking groups are composed of hydrocarbon groups. Therefore, the chemical stability is improved in comparison with the linking groups containing ether bonds, etc. which are contained in conventionally widely used compounds.

R^{f} is a C₁₋₂₀ fluoroalkyl group.

As the number of carbon atoms in the fluoroalkyl group for R^{f}, from 1 to 6 is preferred, from 1 to 4 is more preferred, and from 1 to 3 is particularly preferred, from such a viewpoint that the water and oil repellency or abrasion resistance of the water and oil repellent layer will be superior.

As the fluoroalkyl group for R^{f}, a perfluoroalkyl group is preferred from such a viewpoint that the water and oil repellency or abrasion resistance of the water and oil repellent layer will be superior. Compound (A1) wherein R^{f} is a perfluoroalkyl group has a CF₃— at the terminal. By compound (A1) wherein the terminal is CF₃—, it will be possible to form a water and oil repellent layer with low surface energy, whereby the water and oil repellency and abrasion resistance of the water and oil repellent layer will be superior.

As the fluoroalkyl group for R^{f}, for example, CF₃—, CF₃CF₂—, CF₃CF₂CF₂—, CF₃CF₂CF₂CF₂—, CF₃CF₂CF₂CF₂CF₂—, CF₃CF₂CF₂CF₂CF₂CF₂— or CF₃CF(CF₃)— may be mentioned.

As (R^{f1}O)ₘ, the structure represented by the following formula (D1) is preferred from such a viewpoint that the water and oil repellency or abrasion resistance of the water and oil repellent layer will be superior.

(R^{f11}O)ₘ₁(R^{f12}O)ₘ₂(R^{f13}O)ₘ₃(R^{f14}O)ₘ₄(R^{f15}O)ₘ₅(R^{f16}O)ₘ₆ (D1)

Here,

R^{f11} is a C₁-fluoroalkylene group,

R^{f12} is a C₂-fluoroalkylene group,

R^{f13} is a C₃-fluoroalkylene group,

R^{f14} is a C₄-fluoroalkylene group,

R^{f15} is a C₅-fluoroalkylene group,

R^{f16} is a C₆-fluoroalkylene group,

m1, m2, m3, m4, m5 and m6 each independently represent an integer of 0 or 1 or more, and m1+m2+m3+m4+m5+m6 is an integer of from 1 to 200, and if there are a plurality of R^{f11} to R^{f16}, the plurality of R^{f11} to R^{f16} may be the same or different.

Further, the bonding order of (R^{f11}O) to (R^{f16}O) in the formula (D1) is arbitrary. m1 to m6 in the formula (D1) represent the number of (R^{f11}O) to (R^{f16}O), respectively, and are not ones representing the arrangement. For example, (R^{f15}O)ₘ₅ represents that the number of (R^{f15}O) is m5, and (R^{f5}O)ₘ₅ is not one representing a block arrangement structure. Similarly, the order in which (R^{f11}O) to (R^{f16}O) are listed, is not one representing the bonding order of the respective units.

Further, the C₃₋₆ fluoroalkylene group may be a linear fluoroalkylene group, or may be a fluoroalkylene group having a branched or ring structure.

As R^{f1}, from 50 to 100% of its total number m is preferably a perfluoroalkylene group, more preferably from 80 to 100% is a perfluoroalkylene group, and particularly preferably all of them are perfluoroalkylene groups.

As specific examples of R^{f11}, CHF and CF₂ may be mentioned. As specific examples of R^{f12}, CF₂CF₂, CF₂CHF and CF₂CH₂ may be mentioned. As specific examples of R^{f13}, CF₂CF₂CF₂. CF₂CF₂CHF, CF₂CHFCF₂, CF₂CF₂CH₂, CF₂CH₂CF₂ and CF(CF₃)CF₂ may be mentioned. As specific examples of R^{f14}, CF₂CF₂CF₂CF₂, CF₂CF₂CF₂CH₂, CHFCF₂CF₂CF₂, CF₂CH₂CF₂CF₂ and CF(CF₃)CF₂CF₂, and perfluorocyclobutane-1,2-diyl group may be mentioned. As specific examples of R^{f15}, CF₂CF₂CF₂CF₂CF₂, CF₂CF₂CF₂CF₂CH₂, CHFCF₂CF₂CF₂CF₂ and CF₂CF₂CH₂CF₂CF₂ may be mentioned. As specific examples of R^{f16}, CF₂CF₂CF₂CF₂CF₂CF₂, CF₂CF₂CF₂CF₂CF₂CH₂ and CF₂CF₂CF₂CF₂CF₂CHF may be mentioned.

R^{f2} is a (1+b)-valent hydrocarbon group having fluorine atoms, wherein at least the carbon atom bonded to R¹ has fluorine atom(s). As R², preferred is a hydrocarbon group having b substructures “-CQF-* (where Q is a hydrogen atom, a fluorine atom or CF₃, and -* is a bonding hand to be bonded to R¹)”.

As the above hydrocarbon group, a linear or branched chain hydrocarbon group, an aliphatic hydrocarbon ring, an aromatic hydrocarbon ring, and a combination thereof may be mentioned. The hydrocarbon group may have a double or triple bond in the carbon chain. As the combination, for example, one having a chain hydrocarbon group and an aliphatic hydrocarbon ring bonded, and one having a chain hydrocarbon group and an aromatic hydrocarbon ring bonded, may be mentioned.

The number of carbon atoms in R^{f2} is preferably from 1 to 18, more preferably from 1 to 16.

When b is 1, R^{f2} is a divalent group. In this case, as R^{f2}, a fluoroalkylene group may be mentioned. From such a viewpoint that the water and oil repellency or abrasion resistance of the water and oil repellent layer will be superior, when b is 1, R^{f2} is preferably a C₁₋₆ fluoroalkylene group, particularly preferably a C₁₋₆ perfluoroalkylene group. As specific examples of R^{f2} in this case, —CHF—*, —CF₂—*, CF₂CF₂—*, CF₂CHF—*, CH₂CF₂—*, CF₂CF₂CF₂—*, CF₂CF₂CHF—*, CF₂CHFCF₂—*, CH₂CF₂CF₂—*, CF₂CH₂CF₂—*, CF(CF₃)CF₂—*, CF₂CF₂CF₂CF₂—*, CH₂CF₂CF₂CF₂—*, CHFCF₂CF₂CF₂—*, CF₂CH₂CF₂CF₂—*, CF(CF₃)CF₂CF₂—*, CF₂CF₂CF₂CF₂CF₂—*, CH₂CF₂CF₂CF₂CF₂—*, CHFCF₂CF₂CF₂CF₂—*, CF₂CF₂CH₂CF₂CF₂—*, CF₂CF₂CF₂CF₂CF₂CF₂—*, CH₂CF₂CF₂CF₂CF₂CF₂—* and CF₂CF₂CF₂CF₂CF₂CHF—* may be mentioned.

When b is 2 or more, R^{f2} is a (1+b)-valent group having at least one type of branching point P selected from a tertiary carbon atom, a quaternary carbon atom and a ring structure.

As the carbon atom constituting the branching point, a tertiary carbon atom or a quaternary carbon atom is preferred, from the viewpoint that the compound can easily be produced and from such a viewpoint that the water and oil repellency or abrasion resistance in the water and oil repellent layer will be superior.

As the ring structure constituting the branching point, a 3- to 8-membered aliphatic ring, a 6- to 8-membered aromatic ring, and a fused ring comprising two or more of these rings, may be mentioned from the viewpoint that the compound can easily be produced and from such a viewpoint that the water and oil repellency or abrasion resistance of the water and oil repellent layer will be superior. As the ring structure which constitutes a branching point, the ring structures shown in the following formulae may be mentioned. The following ring structures may be substituted with fluorine atoms. Further, the ring structures may have, as substituents, alkyl groups, cycloalkyl groups, alkenyl groups, aryl groups, etc. which may have halogen atoms.

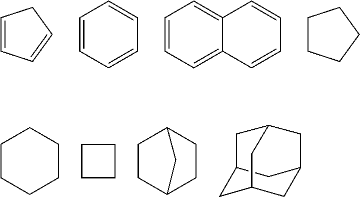

As R^{f2}, preferred is a combination of two or more divalent fluoroalkylene groups and one or more branching points P. In a case where R^{f2} has a hydrocarbon ring, preferred is a combination of a hydrocarbon ring having three or more branching points P and two or more divalent fluoroalkylene groups.

Preferred specific examples of the case where R^{f2} is trivalent or more, are shown below. Here, in the following formulae, R^{F} represents (R^{f1}O)ₘ, -* represents a bonding hand to be bonded to R¹, and R^{F} does not constitute R^{f2}.

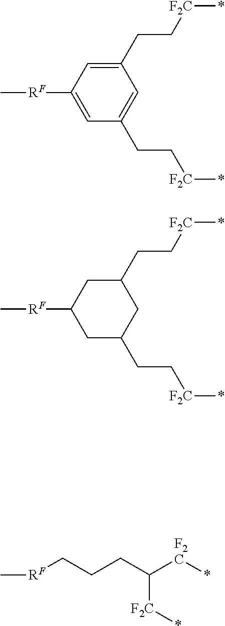

R¹ is a C₁₋₂₀ alkylene group. R¹ has no fluorine atom. The number of carbon atoms in R¹ is preferably from 5 to 20, particularly preferably from 7 to 10, from such a viewpoint that the water and oil repellency or abrasion resistance of the water and oil repellent layer will be superior. Further, from such a viewpoint that the water and oil repellency or abrasion resistance of the water and oil repellent layer will be superior, the number of carbon atoms in R¹ is preferably an odd number, particularly preferably 3, 5, 7, or 9.

R² is a C₂₋₂₀ alkylene group which may have fluorine atom(s). From such a viewpoint that the water and oil repellency or abrasion resistance of the water and oil repellent layer will be superior, the number of carbon atoms in R² is preferably from 3 to 20, more preferably from 3 to 10. Further, it is preferred that among the plurality of R², the number of carbon atoms of at least one, is from 3 to 10, from such a viewpoint that the water and oil repellency or abrasion resistance of the water and oil repellent layer will be superior.

R³ is a hydrogen atom or a C₁₋₁₀ alkyl group which may have fluorine atom(s). As R³, from such a viewpoint that the water and oil repellency or abrasion resistance of the water and oil repellent layer will be superior, a hydrogen atom and a C₁₋₃ alkyl group which may have fluorine atom(s) are preferred, and a hydrogen atom is more preferred.

T is —Si(R)_{3-c}(L)_{c} and is a reactive silyl group.

The reactive silyl group is a group having one or both of hydrolyzable group and hydroxy group bonded to a silicon atom.

A hydrolyzable group is a group that becomes a hydroxy group by hydrolysis reaction. That is, the hydrolyzable silyl group becomes a silanol group (Si—OH) by hydrolysis reaction. The silanol group further undergoes an intermolecular dehydration-condensation reaction to form a Si—O—Si bond. Further, the silanol group undergoes a dehydration-condensation reaction with a hydroxy group (substrate-OH) on the surface of the substrate to form a chemical bond (substrate-O—Si).

As specific examples of the hydrolyzable group, an alkoxy group, an aryloxy group, a halogen atom, an acyl group, an acyloxy group and an isocyanate group may be mentioned. As the alkoxy group, a C₁₋₆ alkoxy group is preferred. As the halogen atom, a chlorine atom is preferred. As the acyl group, a C₁₋₆ acyl group is preferred. As the acyloxy group, a C₁₋₆ acyloxy group is preferred.

As the hydrolyzable group, from the viewpoint that the compound can easily be produced, an alkoxy group and a halogen atom are preferred. As the hydrolyzable group, from the viewpoint that outgassing during coating is little, and storage stability of the compound will be excellent, a C₁₋₄ alkoxy group is preferred, and in a case where the storage stability of the compound for a long time is required, an ethoxy group is particularly preferred, and in a case where the reaction time after coating is to be shortened, a methoxy group is particularly preferred.

As the number of carbon atoms in the alkyl group for R, from the viewpoint that the compound can easily be produced, from 1 to 6 is preferred, from 1 to 3 is more preferred, and from 1 to 2 is particularly preferred.

As c, from such a viewpoint that the adhesion of the water and oil repellent layer will be stronger, 2 and 3 are preferred, and 3 is more preferred.

The plurality of T may be the same or different. From the viewpoint that the compound can easily be produced, it is preferred that the plurality of T are the same groups.

Further, from such a viewpoint that the water or oil repellency or abrasion resistance of the water and oil repellent layer will be superior, it is preferred that two or more T are placed at each terminal, and from such a viewpoint, if b is 1, a is 2 or 3.

Further, from such a viewpoint that the water or oil repellency or abrasion resistance of the water and oil repellent layer will be superior, it is preferred that b is 1. In a case where a plurality of b are present, it is preferred that all b are 1.

Further, from such a viewpoint that the water or oil repellency or abrasion resistance of the water and oil repellent layer will be superior, it is preferred that a is 3. In a case where a plurality of a are present, it is preferred that all a are 3.

As compound (A1) and compound (A2), for example, compounds of the following formulae may be mentioned. Further, the compounds preferably have a weight average molecular weight (Mw)/number average molecular weight (Mn) of at most 1.2 from the viewpoint of durability.

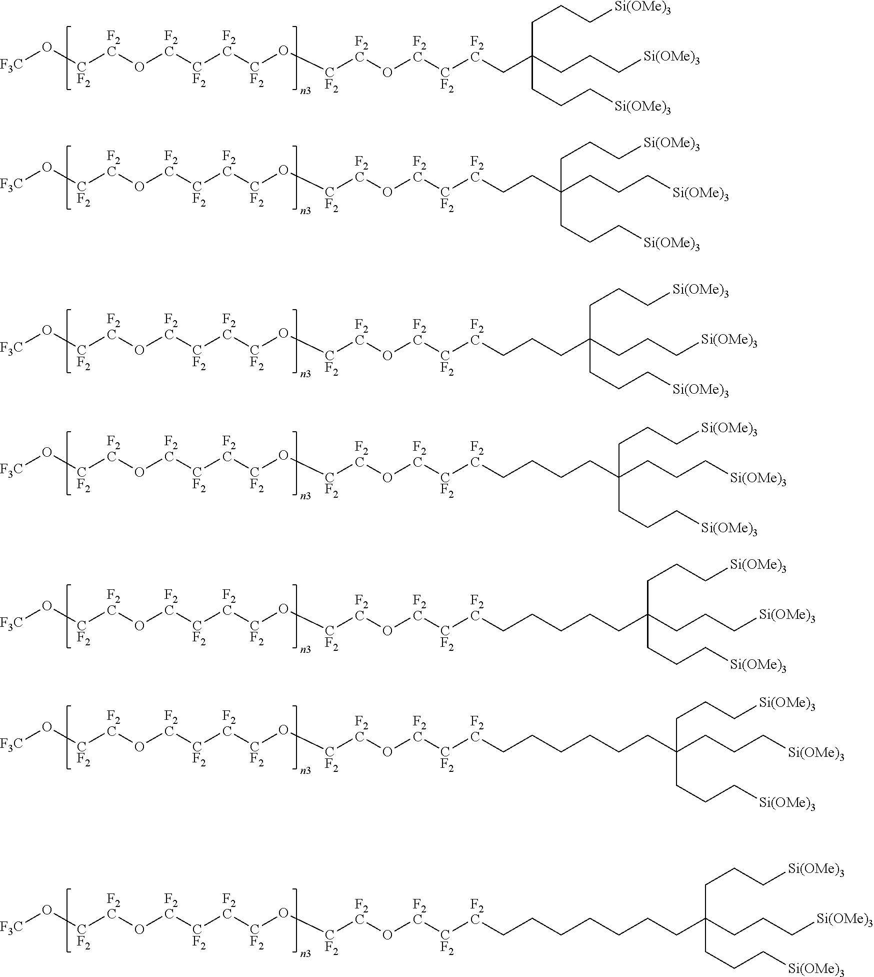

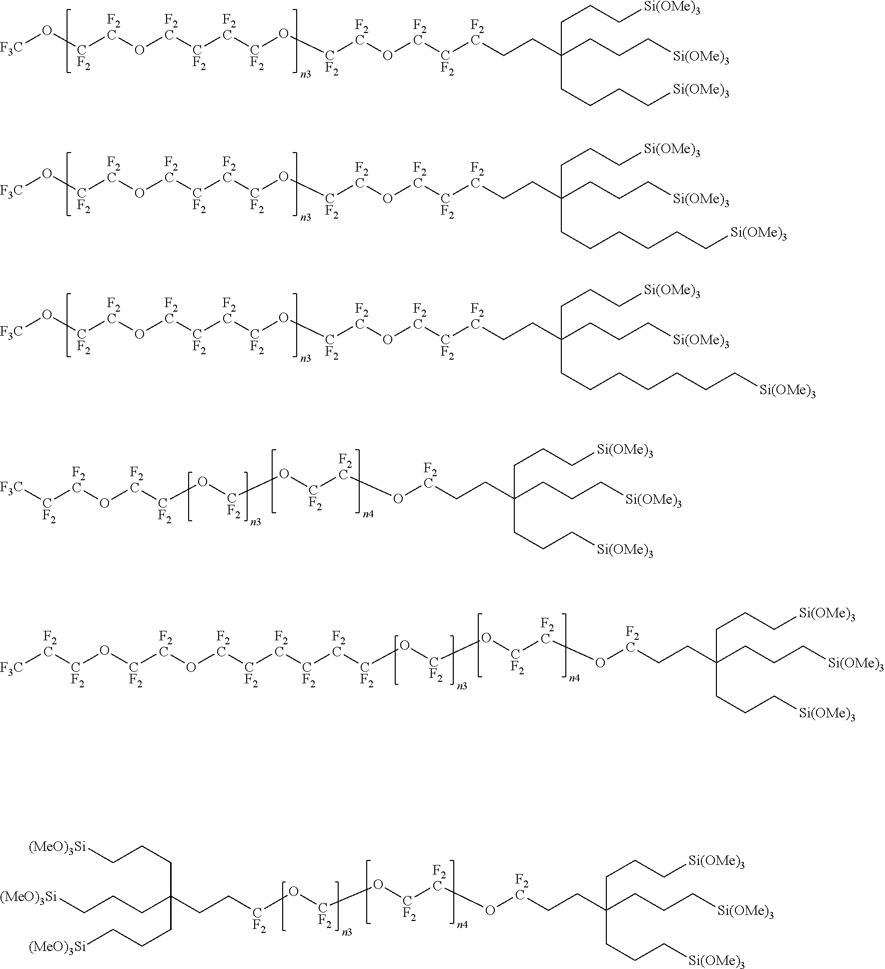

Here, n3 and n4 in the formulae represent the number of repeating units, and are each independently an integer of from 1 to 100.

### (Production Method for Compound (A1) and Compound (A2))

Compound (A1) can be produced, for example, by a method of letting the following compound (A11) and compound (1a) undergo the hydrosilylation reaction. Compound (A2) can be produced, for example, by a method of letting the following compound (A21) and compound (1a) undergo the hydrosilylation reaction. These hydrosilylation reactions can be carried out by known methods.

R^{f}—O—(R^{f1}O)ₘ—R^{f2}[—R¹—C(—R²⁰—CH═CH₂)ₐ(—R³)₃₋ₐ]_{b} (A11)

[(CH₂═CH—R²⁰—)ₐ(R³—)₃₋ₐC—R¹—]_{b}R^{f2}—O—(R¹O)ₘ—R^{f2}[—R¹—C(—R²⁰—CH═CH₂)ₐ(—R³)₃₋ₐ]_{b} (A21)

HSi(R)_{3-c}(L)_{c} (1a)

Here, R²⁰ in the formulae is a single bond or a C₁₋₈ alkylene group which may have fluorine atom(s), and the symbols other than R²⁰ are the same as the symbols in the above formula (A1) or formula (A2).

—R²⁰—CH═CH₂ becomes R² after the hydrosilylation. As R²⁰, the same group as R² may be mentioned, and the preferred form is also the same.

### (Production Method for Compound (A11) and Compound (A21))

Compound (A11) can be produced, for example, by a method of reacting the following compound (A12) and the following compound (B2). Compound (A21) can be produced, for example, by a method of reacting the following compound (A22) and the following compound (B2).

R^{f}—O—(R^{f1}O)ₘ—R^{f2}—CH₂-L² (A12)

L²-CH₂—R^{f2}—O—(R^{f1}O)ₘ—R^{f2}—CH₂-L² (A22)

(CH₂═CH—R²⁰—)ₐ(R³—)₃₋ₐC—R²¹—MgX (B2)

Here,

L² is a sulfonate group,

R²¹ is a single bond or a C₁₋₁₉ alkylene group,

X is a chlorine atom, a bromine atom or an iodine atom, and

other symbols are the same as the symbols in the above formula (A1) or formula (A2).

Compound (A12) or compound (A22) and compound (B2) react as shown by the following scheme (1).

—R^{f2}—CH₂-L²+XMg—R²¹—→—R^{f2}—CH₂—R²¹— Scheme (1)

Here, in scheme (1), each symbol is as described above.

Further, CH₂—R²¹ after the above reaction corresponds to R¹ of the compound.

Since L² is a sulfonate group (—O—SO₂—R²²), the reaction proceeds. Here, R²² is an organic group. By selecting a sulfonate group as L², the reaction of the above scheme (1) can be carried out under relatively mild conditions and in high yield.

As specific examples of the sulfonate group, a tosylate group (OTs), a mesylate group (OMs), a triflate group (OTf) and a nonaflate group (ONf) may be mentioned. Among them, from the viewpoint of the reaction yield in scheme (1), a triflate group is preferred.

Compound (A12) or compound (A22) can be produced by e.g. a method of sulfonation by reacting trifluoromethanesulfonic anhydride, tosylchloride, mesylchloride or the like to a compound represented by the following compound (A13) or compound (A23) in the presence of an organic amine compound such as triethylamine or pyridine.

R^{f}—O—(R^{f1}O)ₘ—R^{f2}—CH₂—OH (A13)

L²-CH₂—R^{f2}—O—(R^{f1}O)ₘ—R^{f2}—CH₂—OH (A23)

Here, A¹, A² and n in the formulae are as described above.

Compound (A13) and compound (A23) can be produced by referring to, for example, WO2017/038830, etc.

Compound (B2) can be produced, for example, by a method of reacting the following compound (B1) and metallic magnesium.

(CH₂═CH—R²⁰—)ₐ(R³—)₃₋ₐC—R²¹—X (B1)

Here, R²⁰, R²¹, R³, X and a in the formula are the same as in compound (B2).

As suitable examples of compound (B2), the following ones may be mentioned.

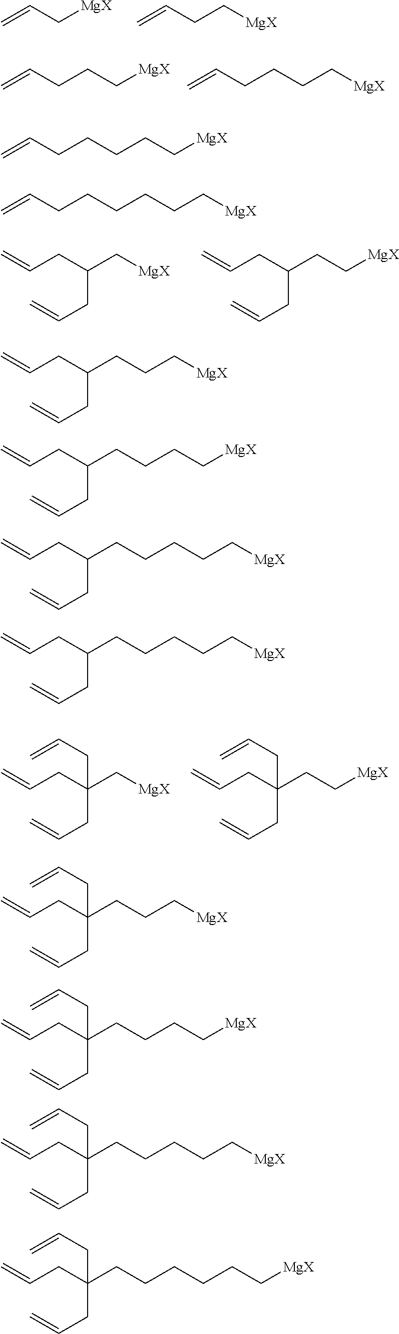

In the reaction of scheme (1), the amount of compound (B2) to be used is preferably from 1 to 30 equivalents, more preferably from 3 to 20 equivalents, particularly preferably from 5 to 15 equivalents, to the total number of sulfonate groups L² which compound (A12) or compound (A12) has, from the viewpoint of improving the yield of the desired product.

In the reaction of scheme (1), it is preferred to use a transition metal compound as a catalyst from the viewpoint of improving the reactivity and enabling a higher yield. The transition metal compound can be suitably selected for use from known catalysts to be used in a Grignard reaction. As the transition metal compound, compounds containing Group 3 to Group 12 elements in the periodic table as transition metals are preferred, and among them, compounds containing Group 8 to Group 11 elements are preferred. As the Group 8 to Group 11 elements, among them, it is preferred to contain at least one type of element selected from the group consisting of copper, nickel, palladium, cobalt and iron, and it is particularly preferred to contain copper.

When the transition metal compound contains copper, the copper may be a zero-, monovalent, divalent or trivalent compound, but from the standpoint of the catalytic ability, it is preferably a monovalent or divalent copper salt or complex salt. Further, from the viewpoint of easy availability, it is more preferably copper chloride.

The amount of the transition metal compound to be used is preferably from 0.1 to 50 mol %, more preferably from 1 to 30 mol %, particularly preferably from 2 to 20 mol %, to the total number of sulfonate groups L².

Further, the transition metal compound may be used in combination with a ligand. The use of a ligand improves the yield of the target product. On the other hand, in the present production method, the ligand may not be used, since a sufficient yield can be obtained without the ligand.

As specific examples of the above ligand, 1,3-butadiene, phenylpropyne and tetramethylethylenediamine (TMEDA) may be mentioned. In a case where a ligand is to be used, the amount to be used is preferably from 0.01 to 2.0 equivalents, more preferably from 0.1 to 1.2 equivalents, to the total number of sulfonate groups L², from the viewpoint of improving the yield of the target product.

Further, the reaction in scheme (1) is usually carried out in a solvent. The solvent may be used as suitably selected from solvents capable of dissolving the above compound (A12), compound (A13) and compound (B2). The solvent may be one type alone or may be a mixed solvent having two or more types combined.

For example, in a case where compound (A12) or compound (A13) is a compound with a relatively low fluorine atom content (ratio of fluorine atoms occupying in the molecular weight of the compound molecules), the solvent is not particularly limited so long as it is a solvent inert to the reaction. As the reaction-inert solvent, among them, an ether type solvent such as diethyl ether, tetrahydrofuran or dioxane is preferred, and tetrahydrofuran is more preferred.

Further, in a case where compound (A12) or compound (A13) is a compound with a relatively high fluorine atom content, a mixed solvent having an ether type solvent and a fluorinated solvent combined is preferred.

Specific examples of the fluorinated solvent include hydrofluorocarbons (1H,4H-perfluorobutane, 1H-perfluorohexane, 1,1,1,3,3-pentafluorobutane, 1,1,2,2,3,3,4-heptafluorocyclopentane, 2H,3H-perfluoropentane, etc.), hydrochlorofluorocarbons (3,3-dichloro-1,1,1,2,2-pentafluoropropane, 1,3-dichlorol,1,2,2,3-pentafluoropropane (HCFC-225cb), etc.), hydrofluoroethers (CF₃CH₂OCF₂CF₂H (AE3000), (perfluorobutoxy)methane, (perfluorobutoxy)ethane, etc.), hydrochlorofluoroolefins ((Z)-1-chloro-2,3,3,4,4,5,5-heptafluoro-1-pentene (HCFO-1437dycc (Z)isomer), (E)-1-chloro-2,3,3,4,4,5,5-heptafluoro-1-pentene (HCFO-1437dycc (E)isomer), (Z)-1-chloro-2,3,3-trifluoro-1-propene (HCFO-1233yd (Z)isomer), (E)-1-chloro-2,3,3-trifluoro-1-propene (HCFO-1233yd (E)isomer) etc.) and fluorinated aromatic compounds (perfluorobenzene, m-bis(trifluoromethyl)benzene (SR-solvent), p-bis(trifluoromethyl)benzene, etc.).

The reaction of scheme (1) may be carried out, for example, by preparing a solution containing compound (A12) or compound (A13), adding a transition metal compound and, if necessary, a ligand, followed by the addition of a separately prepared compound (B2) solution.

The reaction temperature in scheme (1) may be set to be, for example, from −20° C. to 66° C. (boiling point of tetrahydrofuran), and it is preferred to set the temperature from −20° C. to 40° C.

The thickness of the water and oil repellent layer is preferably from 1 to 100 nm, particularly preferably from 1 to 50 nm. When the thickness of the water and oil repellent layer is at least the above lower limit value, it will be possible to sufficiently obtain the effect of the water and oil repellent layer. When the thickness of the water and oil repellent layer is at most the above upper limit value, the utilization efficiency will be high.

The thickness of the water and oil repellent layer can be calculated from the vibration period of an interference pattern by obtaining the interference pattern of reflected X-rays by the X-ray reflectometry (XRR) using an X-ray diffractometer for thin film analysis.

[Method for Producing Substrate with Water and Oil Repellent Layer]

In the method for producing a substrate with a water and oil repellent layer according to the present invention, an undercoat layer containing an oxide containing silicon and the above specific element, is formed on a substrate, and then, on the undercoat layer, a water and oil repellent layer made of a hydrolytic condensation product of a fluorinated ether compound selected from the group consisting of compound (A1) and compound (A2), is formed.

### (Formation of the Undercoat Layer)

The undercoat layer is formed by a vapor deposition method using a vapor deposition material, or by a wet coating method.

### <Vapor Deposition Method>

The vapor deposition material to be used in the vapor deposition method includes an oxide containing silicon and a specific element.

As specific examples of the form of vapor deposition material, a powder, a melt, a sintered material, a granulated material and a crushed material may be mentioned, and from the viewpoint of handling efficiency, a melt, a sintered material and a granulated material are preferred.

Here, a melt means a solid obtained by melting the powder of a vapor deposition material at a high temperature and then cooling and solidifying it. A sintered material means a solid obtained by sintering the powder of a vapor deposition material, and if necessary, instead of the powder of a vapor deposition material, a molded material may be used by press forming the powder. A granulated material means a solid obtained by kneading a powder of a vapor deposition material and a liquid medium (e.g. water or an organic solvent) to obtain particles, and then drying the particles.

The vapor deposition material may be produced, for example, by the following methods.
A method of mixing a powder of silicon oxide and a powder of an oxide of a specific element to obtain a powder of a vapor deposition material.
A method of kneading a powder of the above vapor deposition material and water to obtain particles, and then drying the particles to obtain granules of the vapor deposition material.
The method of drying a mixture having a powder containing silicon (e.g. a powder made of silicon oxide, silica sand or silica gel), a powder containing a specific element (e.g. a powder of an oxide of a specific element, a carbonate, a sulfate, a nitrate, an oxalate or a hydroxide) and water, mixed, and then sintering the mixture after drying or a molded product having it press-molded, to obtain a sintered material.
A method of melting a powder containing silicon (e.g. a powder made of silicon oxide, silica sand or silica gel) and a powder containing a specific element (e.g. a powder of an oxide of a specific element, a carbonate, a sulfate, a nitrate, an oxalate or a hydroxide) at a high temperature, followed by cooling and solidifying the molten product to obtain a melt.

As a specific example of the vapor deposition method using a vapor deposition material, a vacuum vapor deposition method may be mentioned. The vacuum vapor deposition method is a method of evaporating a vapor deposition material in a vacuum chamber and adhering it to the surface of the substrate.

As the temperature at the time of vapor deposition (e.g. at the time of using a vacuum vapor deposition apparatus, the temperature of the boat in which the deposition material is placed), from 100 to 3,000° C. is preferred, and from 500 to 3,000° C. is particularly preferred.

As the pressure at the time of vapor deposition (e.g. at the time of using a vacuum vapor deposition apparatus, the pressure in the chamber where the vapor deposition material is placed), at most 1 Pa is preferred, and at most 0.1 Pa is particularly preferred.

In the case of forming the undercoat layer by using a vapor deposition material, one vapor deposition material may be used, or two or more vapor deposition materials containing different elements may be used.

As specific examples of the evaporation method for a vapor deposition material, a resistance heating method in which the vapor deposition material is melted and evaporated on a resistance heating boat made of high-melting-point metal, and an electron gun method, in which the vapor deposition material is irradiated with an electron beam, so that the vapor deposition material is directly heated to melt the surface and evaporated. As the evaporation method for a vapor deposition material, the electron gun method is preferred, from such a viewpoint that it can heat locally whereby even a high-melting-point material can be evaporated, and from such a viewpoint that the area not irradiated by the electron beam is at a low temperature whereby there is no risk of a reaction with the container or contamination by impurities.

As the evaporation method for the vapor deposition material, multiple boats may be used, or a single boat may be used as all the vapor deposition materials be contained therein. The vapor deposition method may be co-vaper deposition, alternating vapor deposition, etc. Specifically, there may be a case of using silica and a specific element source as mixed in the same boat, a case of co-vapor depositing silica and a specific element source as put in separate boats, and a case of alternately vapor depositing them as put in separate boats in the same manner. The conditions, order, etc. for the vapor deposition are suitably selected depending on the construction of the undercoat layer.

### <Wet Coating Method>

In the wet coating method, an undercoat layer is formed on a substrate by a wet coating method using a coating solution containing a silicon-containing compound, a compound containing a specific element and a liquid medium.

Specific examples of the silicon compound include silicon oxide, silicic acid, a partial condensate of silicic acid, an alkoxysilane and a partial hydrolytic condensate of an alkoxysilane.

Specific examples of the compound containing a specific element include an oxide of a specific element, an alkoxide of a specific element, a carbonate of a specific element, a sulfate of a specific element, a nitrate of a specific element, an oxalate of a specific element and a hydroxide of a specific element.

Specific examples of the liquid medium include water and an organic solvent. Specific examples of the organic solvent include a fluorinated organic solvent and a non-fluorinated organic solvent. As the organic solvent, one type may be used alone, or two or more types may be used in combination.

Specific examples of the fluorinated organic solvent include a fluorinated alkane, a fluorinated aromatic compound, a fluoroalkyl ether, a fluorinated alkylamine and a fluoroalcohol.

As the fluorinated alkane, a C₄₋₈ compound is preferred, and, for example, C₆F₁₃H (AC-2000: product name, manufactured by AGC Inc.), C₆F₁₃C₂H₅ (AC-6000: product name, manufactured by AGC Inc.), C₂F₅CHFCHFCF₃ (Bartrel: product name, manufactured by DuPont) may be mentioned.

Specific examples of the fluorinated aromatic compound include hexafluorobenzene, trifluoromethylbenzene, perfluorotoluene, 1,3-bis(trifluoromethyl)benzene and 1,4-bis(trifluoromethyl)benzene.

As the fluoroalkyl ether, a C₄₋₁₂ compound is preferred, and, for example, CF₃CH₂OCF₂CF₂H (AE-3000: product name, manufactured by AGC Inc.), C₄F₉OCH₃ (Novec-7100: product name, manufactured by 3M), C₄F₉OC₂H₅ (Novec-7200: product name, manufactured by 3M) and C₂F₅CF(OCH₃)C₃F₇ (Novec-7300: product name, manufactured by 3M) may be mentioned.

Specific examples of the fluorinated alkylamine include perfluorotripropylamine and perfluorotributylamine.

Specific examples of the fluoroalcohol include 2,2,3,3-tetrafluoropropanol, 2,2,2-trifluoroethanol and hexafluoroisopropanol.

As the non-fluorinated organic solvent, a compound consisting only of hydrogen atoms and carbon atoms, and a compound consisting only of hydrogen atoms, carbon atoms and oxygen atoms, are preferred, and, specifically a hydrocarbon type organic solvent, a ketone type organic solvent, an ether type organic solvent, an ester type organic solvent and an alcohol type organic solvent may be mentioned.

Specific examples of the hydrocarbon type organic solvent include hexane, heptane and cyclohexane.

Specific examples of the ketone type organic solvent include acetone, methyl ethyl ketone and methyl isobutyl ketone.

Specific examples of the ether type organic solvent include diethyl ether, tetrahydrofuran and tetraethylene glycol dimethyl ether.

Specific examples of the ester type organic solvent include ethyl acetate and butyl acetate.

Specific examples of the alcohol type organic solvent include isopropyl alcohol, ethanol and n-butanol.

The content of the liquid medium is preferably from 0.01 to 20 mass %, particularly preferably from 0.01 to 10 mass %, to the total mass of the coating liquid to be used to form the undercoat layer.

Specific examples of the wet coating method for forming the undercoat layer include a spin coating method, a wipe coating method, a spray coating method, a squeegee coating method, a dip coating method, a die coating method, an inkjet method, a flow coating method, a roll coating method, a casting method, a Langmuir-Blodgett method and a Gravure coating method.

It is preferred that after wet coating with the coating solution, the coating film is dried. As the drying temperature of the coating film, from 20 to 200° C. is preferred, and from 80 to 160° C. is particularly preferred.

### (Formation of Water and Oil Repellent Layer)

The water and oil repellent layer may be formed by either production method of dry coating or wet coating by using compound (A1) or compound (A2), or a composition containing compound (A1) or compound (A2) and a liquid medium (hereinafter referred to as the “composition”).

Specific examples of the liquid medium contained in the composition are the same as those listed for the coating solution to form the undercoat layer, and therefore, their description is omitted.

The water and oil repellent layer may be produced, for example, by the following methods.
A method of forming a water and oil repellent layer on the surface of an undercoat layer by treating the surface of the undercoat layer by a dry coating method using compound (A1) or compound (A2), or the composition.
A method of forming a water and oil repellent layer on the surface of an undercoat layer by applying the composition to the surface of the undercoat layer by the wet coating method, followed by drying.

Specific examples of the dry coating method include a vacuum vapor deposition method, a CVD method and a sputtering method. Among these, the vacuum vapor deposition method is preferred from the viewpoint of suppressing the decomposition of the fluorinated compound and from the viewpoint of the simplicity of the equipment. At the time of vacuum vapor deposition, a pellet-like substance having compound (A1) or compound (A2), or the composition impregnated in a porous metal such as iron or steel, may be used.

Specific examples of the wet coating method are the same as in the case of forming the undercoat layer by the wet coating method, and therefore, their description is omitted.

As the drying temperature after wet coating the composition, from 20 to 200° C. is preferred, and from 80 to 160° C. is particularly preferred.

The content of compound (A1) or compound (A2) in the composition is preferably from 0.01 to 50 mass %, particularly preferably from 1 to 30 mass %, to the total mass of the composition.

The content of the liquid medium in the composition is preferably from 50 to 99.99 mass %, particularly preferably from 70 to 99.99 mass %, to the total mass of the composition.

To improve the abrasion resistance of the water and oil repellent layer, as the case requires, an operation to accelerate the reaction of compound (A1) or compound (A2) with the undercoat layer, may be carried out. As such an operation, heating, humidification, light irradiation, etc. may be mentioned. For example, by heating a substrate with an undercoat layer having a water and oil repellent layer formed in an atmosphere having moisture, a reaction such as a hydrolytic decomposition reaction of reactive silyl groups contained in compound (A1) or compound (A2) to silanol groups, formation of siloxane bond by a condensation reaction of silanol groups, and a condensation reaction between silanol groups on the surface of the undercoat layer and silanol groups of the fluorinated compound, can be accelerated.

After the surface treatment, compounds in the water and oil repellent layer that are not chemically bonded to other compounds or the silicon oxide layer may be removed as the case requires. As a specific method, for example, a method of pouring a solvent over the water and oil repellent layer, a method of wiping it off with a cloth soaked with a solvent, or a method of acid washing the surface of the water and oil repellent layer, may be mentioned.

The substrate with a water and oil repellent layer of the present invention is useful as an optical component to be used as a part of components for the following products, a touch panel, an antireflection film, an antireflection glass, a SiO₂ treated glass, a tempered glass, a sapphire glass, a quartz substrate, a mold metal, etc.

Products: A car navigation system, a cellular phone, a digital camera, a digital video camera, a portable information terminal (PDA), a portable audio player, a car audio equipment, a game equipment, an eyeglass lens, a camera lens, a lens filter, sunglasses, a medical equipment (such as a stomach camera), a copier, a personal computer (PC), a liquid crystal display, an organic EL display, a plasma display, a touch panel display, a protective film, an antireflection film, an antireflection glass, a nanoimprint template, a mold, etc.

### EXAMPLES

In the following, the present invention will be described in detail with reference to Examples. Ex. 1 and Ex. 8 to 11 are Comparative Examples, and Ex. 2 to 7 and 12 are Examples of the present invention. However, the present invention is not limited to these Examples. The amounts of the respective components in Tables given below are shown on a mass basis.

### Synthesis Example 1: Synthesis of Compound (1-1)

The following compound (1-1) was obtained in accordance with the method described in Example 7 of WO2013/121984.

CF₃—O—(CF₂CF₂O—CF₂CF₂CF₂CF₂O)ₙ(CF₂CF₂O)—CF₂CF₂CF₂—CH₂OH (1-1)

The average value of the number n of repeating units is 13.

### Synthesis Example 2: Synthesis of Compound (1-2)

The above compound (1-1) (6.80 g, 1.48 mmol), 2,6-lutidine (0.759 g, 7.08 mmol) and AE3000 (28.0 g) were mixed, and the obtained solution was stirred at 0° C. To the obtained solution, anhydrous trifluoromethanesulfonic acid (0.987 g, 3.50 mol) was added, followed by stirring at room temperature. The obtained solution was washed with water, then the solvent was distilled off, and flash column chromatography using silica gel was performed to obtain 6.81 g of the following compound (1-2).

CF₃—O—(CF₂CF₂O—CF₂CF₂CF₂CF₂O)ₙ(CF₂CF₂O)—CF₂CF₂CF₂—CH₂OTf (1-2)

The average value of the number n of repeating units is 13, and OTf is a triflate: —O—S(═O)₂(—CF₃).

### NMR Spectrum of Compound (1-2);

¹H-NMR (400 MHz, Chloroform-d) δ (ppm): 4.78 (t, J=12.3 Hz, 2H).

¹⁹F-NMR (376 MHz, Chloroform-d)

δ(ppm):−55.28, −74.11, −82.86, −88.07, −90.20, −119.84, −125.28, −126.16.

### Synthesis Example 3: Synthesis of Compound (2-1)

Diethyldiallylmalonate (60.0 g, 250 mmol), lithium chloride (23.7 g, 559 mmol), water (6.45 g, 360 mmol) and dimethyl sulfoxide (263 g) were mixed, and the obtained solution was stirred at 160° C. After cooling the obtained solution to room temperature, water was added and extracted with ethyl acetate. Hexane was added to the obtained organic layer, followed by washing with saturated brine and further by drying with sodium sulfate. After filtration of the obtained solution, the solvent was distilled off from the filtrate to obtain 39.5 g of the following compound (2-1).

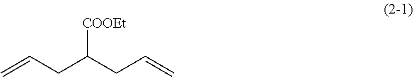

### NMR Spectrum of Compound (2-1);

¹H-NMR (400 MHz, Chloroform-d) δ (ppm): (ddt, J=17.1, 10.1, 7.0 Hz, 2H), 5.06 to 4.94 (m, 4H), 4.09 (q, J=7.1 Hz, 2H), 2.47 (ddd, J=14.0, 8.0, 6.1 Hz, 1H), 2.33 (dt, J=14.9, 7.5 Hz, 2H), 2.22 (dt, J=14.1, 6.5 Hz, 2H), 1.21 (t, J=7.1 Hz, 3H).

### Synthesis Example 4: Synthesis of Compound (2-2)

THF (260 mL) and diisopropylamine (41.5 mL, 294 mmol) were mixed, and then the solution was cooled to −78° C. To the obtained solution, a n-butyl lithium hexane solution (2.76 M, 96.6 mL, 294 mmol) was added, and the temperature was raised to 0° C. The solution was stirred and then cooled to −78° C., to prepare a THF solution of lithium diisopropylamide (LDA). The above compound (2-1) (39.5 g, 235 mmol) was added to the THF solution, followed by stirring, and then to the obtained solution, allyl bromide (24.1 mL, 278 mmol) was added. The obtained solution was raised to 0° C., 1M hydrochloric acid (100 mL) was added, and THF was distilled off under reduced pressure. The obtained components were extracted with dichloromethane, and to the obtained solution, sodium sulfate was added. After filtration of the obtained solution, the solvent was distilled off from the filtrate, and flash column chromatography using silica gel was performed to obtain 45.0 g of compound (2-2).

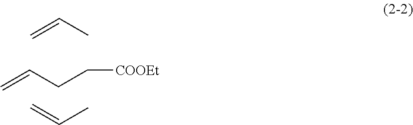

### NMR Spectrum of Compound (2-2);

¹H-NMR (400 MHz, Chloroform-d) δ (ppm): 5.74 to 5.62 (m, 3H), 5.04 (dd, J=13.6, 1.9 Hz, 6H), 4.10 (q, J=7.1 Hz, 2H), 2.29 (d, J=7.4 Hz, 6H), 1.22 (t, J=7.1 Hz, 3H).

### Synthesis Example 5: Synthesis of Compound (2-3)

The above compound (2-2) (45.0 g, 216 mmol) was dissolved in THF (620 mL), and the obtained solution was cooled to 0° C. To the obtained solution, a THF solution of lithium aluminum hydride (104 mL, 260 mmol) was added, followed by stirring. To the obtained solution, water and a 15% sodium hydroxide aqueous solution were added, followed by stirring at room temperature, and diluting with dichloromethane. After filtration of the obtained solution, the solvent was distilled off from the filtrate, and flash column chromatography using silica gel was performed to obtain 31.3 g of the following compound (2-3).

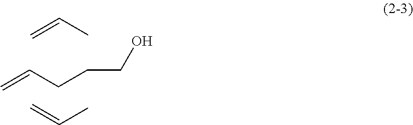

### NMR Spectrum of Compound (2-3);

¹H-NMR (400 MHz, Chloroform-d) δ (ppm): 5.90 to 5.76 (m, 3H), 5.10 to 5.02 (m, 6H), 3.38 (s, 2H), 2.03 (dt, J=7.5, 1.2 Hz, 6H), 1.45 (s, 1H).

### Synthesis Example 6: Synthesis of Compound (B1-1)

Acetonitrile (380 mL), the above compound (2-3) (31.3 g, 188 mmol), triphenylphosphine (64.3 g, 245 mmol) and carbon tetrachloride (33.9 g, 221 mmol) were mixed, and the obtained solution was stirred at 90° C. The obtained solution was concentrated, and then, ethyl acetate/hexane was added, followed by stirring. The obtained solution was filtered, and the filtrate was concentrated, and then, by distillation (70° C., 3 hPa), 28.2 g of the following compound (B1-1) was obtained.

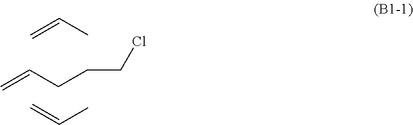

### NMR Spectrum of Compound (B1-1);

¹H-NMR (400 MHz, Chloroform-d) δ (ppm): 5.83 to 5.67 (m, 3H), 5.16 to 5.01 (m, 6H), 3.32 (s, 2H), 2.05 (dt, J=7.5, 1.1 Hz, 6H).

### Synthesis Example 7: Synthesis of Compound (B2-1)

To magnesium (2.36 g, 97.2 mmol), THF (35 mL) and iodine (0.180 g, 0.71 mmol) were added, and the obtained solution was stirred at room temperature. To the obtained solution, a THF (35 mL) solution of the above compound (B1-1) (14.0 g, 75.9 mmol) was added, followed by heating and refluxing for 2 hours to prepare a solution (1.0 M) of the following compound (B2-1).

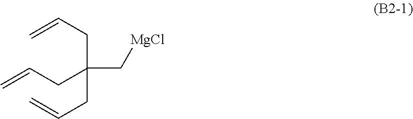

### Synthesis Example 8: Synthesis of Compound (A-1′)

CuCl₂ (16.0 mg, 0.119 mmol), 1-phenyl-I-propyne (0.052 g, 0.45 mmol), 1,3-bistrifluoromethylbenzene (24 mL) and the above compound (1-2) (4.00 g) were mixed, and then, to the obtained solution, the above compound (B2-1) (5.0 mL, 1.0 M, 5.0 mmol) was added. The obtained solution was stirred at room temperature, then washed with 1 M hydrochloric acid and dried over sodium sulfate. After filtration of the solution, the solvent was distilled off from the filtrate, and AC6000 was added. The obtained solution was washed with methanol and then subjected to flash column chromatography using silica gel to obtain 0.139 g of the following compound (A-1′) being a precursor for compound (A-1).

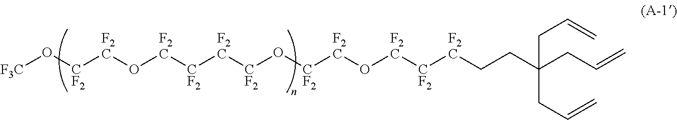

The average value of the number n of repeating units is 10.

### NMR Spectrum of Compound (A-1′);

¹H-NMR (400 MHz, Chloroform-d) δ (ppm): 5.77 (ddt, J=14.9, 10.7, 7.4 Hz, 3H), 5.07 to 4.99 (m, 6H), 2.19 to 2.05 (m, 2H), 1.97 (d, J=7.4 Hz, 6H), 1.59 to 1.50 (m, 2H).

¹⁹F-NMR (376 MHz, Chloroform-d) δ (ppm): −55.29, −82.90, −88.13, −90.24 (d, J=8.0 Hz), −114.62, −125.34, −126.49.

### Synthesis Example 9: Synthesis of Compound (A-1)

AC2000 (0.89 g), the above compound (A-1′) (0.139 g), a xylene solution of platinum/1,3-divinyl-1,1,3,3-tetramethyldisiloxane complex (platinum content 2%, 5.5 mg), aniline (0.8 mg) and trimethoxysilane (22.7 mg, 0.185 mmol) were mixed, and the obtained solution was stirred at 40° C. Thereafter, from the obtained solution, the solvent was distilled off under reduced pressure to obtain 0.140 g of the following compound (A-1).

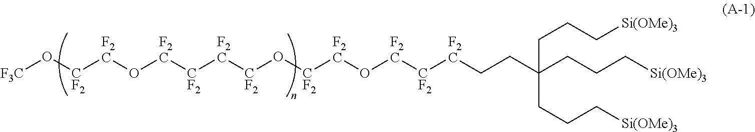

The average value of the number n of repeating units is 10.

### NMR Spectrum of Compound (A-1);

¹H-NMR (400 MHz, Chloroform-d) 53.60 (s, 27H), 2.23 to 1.95 (m, 2H), 1.63 to 1.28 (m, 14H), 0.67 (t, J=7.6 Hz, 6H).

¹⁹F-NMR (376 MHz, Chloroform-d) δ−55.33, −82.95, −88.17, −90.13 to −90.40 (m), −114.07 to −114.32 (m), −125.38, −126.04.

### Synthesis Example 10: Synthesis of Compound (A-2)

The following compound (A-2) was obtained in accordance with the method described in Example 6 of WO2017/038830.

CF₃—O—(CF₂CF₂O—CF₂CF₂CF₂CF₂O)ₙ(CF₂CF₂O)—CF₂CF₂CF₂—CH₂OCH₂—C[CH₂CH₂CH₂—Si(OCH₃)₃]₃ (A-2)

The average value of the number n of repeating units is 13.

### Synthesis Example 11: Synthesis of Compound (B1-2)

1-Bromo-3-chloropropane (2.90 g, 18.3 mmol), 1-phenyl-1-propyne (0.220 g, 1.89 mmol) and CuCl₂ (0.051 g, 0.38 mmol) were mixed, and the obtained solution was stirred at 0° C. To the obtained solution, compound (B2-1) (0.80M, 26.0 mL, 20.9 mmol) was added, followed by further stirring. To the obtained solution, 1 M hydrochloric acid was added, followed by extraction with dichloromethane, and sodium sulfate was added. The obtained solution was filtered, and the filtrate was concentrated, followed by distillation (100° C., 3 hPa) to obtain 3.29 g of the following compound (B1-2).

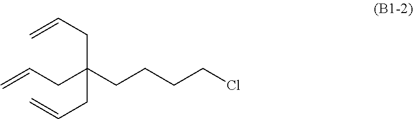

### NMR Spectrum of Compound (B1-2);

¹H-NMR (400 MHz, Chloroform-d) δ (ppm): 5.76 (ddt, J=16.6, 10.6, 7.4 Hz, 3H), 5.09 to 4.93 (m, 6H), 3.50 (t, J=6.7 Hz, 2H), 1.96 (dt, J=7.4, 1.2 Hz, 6H), 1.76 to 1.61 (m, 2H), 1.45 to 1.29 (m, 2H), 1.24 to 1.08 (m, 2H).

### Synthesis Example 12: Synthesis of Compound (B2-2)

To magnesium (0.174 g, 7.16 mmol), THF (2.6 mL) and iodine (12.7 mg, 0.050 mmol) were added, and the obtained solution was stirred at room temperature. To the obtained solution, a THF (2.6 mL) solution of the above compound (B1-2) (1.30 g, 5.74 mmol) was added, followed by heating and refluxing to prepare a solution (1.0 M) of the following compound (B2-2).

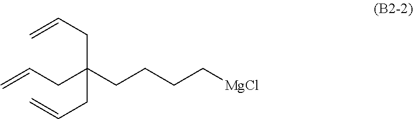

### Synthesis Example 13: Synthesis of Compound (3-1)

FLUOROLINK D4000 (manufactured by Solvay Specialty Polymers) (4.03 g), 2,6-lutidine (0.759 g, 7.08 mmol) and AE3000 (28.0 g) were mixed, and the obtained solution was stirred at 0° C. To the obtained solution, anhydrous trifluoromethanesulfonic acid (0.987 g, 3.50 mol) was added, followed by further stirring at room temperature. After washing the obtained solution with water, the solvent was distilled off, and flash column chromatography using silica gel was performed to obtain 3.56 g of the following compound (3-1).

TfOCH₂CF₂(OCF₂)ₚ(OCF₂CF₂)_{q}-OCF₂CH₂OTf (3-1)

The average value of the number p of repeating units is 22, the average value of q is 25, and OTf is triflate.

### NMR Spectrum of Compound (3-1):

¹H-NMR (400 MHz, Chloroform-d) δ (ppm): 4.89 (q, J=8.4 Hz, 1H).

### Synthesis Example 14: Synthesis of Compound (A-3′)

CuCl₂ (7.0 mg, 0.052 mmol), 1-phenyl-1-propyne (0.026 g, 0.22 mmol), 1,3-bistrifluoromethylbenzene (15 mL) and the above compound (1-2) (1.62 g) were mixed, and then, to the obtained solution, the above compound (3-1) (4.0 mL, 1.0 M, 4.0 mmol) was added. The obtained solution was stirred at room temperature, then washed with 1M hydrochloric acid, and dried over sodium sulfate. After filtration of the obtained solution, the solvent was distilled off from the filtrate, and AC6000 was added. After washing the obtained solution with methanol, flash column chromatography using silica gel was performed to obtain 0.202 g of the following compound (A-3′), which becomes to be the precursor for compound (A-3).

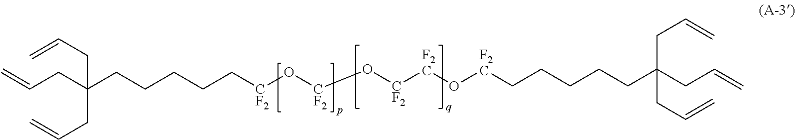

The average value of the number p of repeating units is 22, and the average value of q is 25.

### NMR Spectrum of Compound (A-3′),

¹H-NMR (400 MHz, Chloroform-d) δ (ppm): 5.90 to 5.66 (m, 6H), 5.07 to 4.90 (m, 12H), 2.19 to 1.92 (m, 16H), 1.70 to 1.10 (m, 16H).

### Synthesis Example 15: Synthesis of Compound (A-3)

AC2000 (1.2 g), the above compound (A-3′) (0.202 g), a xylene solution of platinum/1,3-divinyl-1,1,3,3-tetramethyldisiloxane complex (platinum content: 2%, 7.0 mg), aniline (1.4 mg) and trimethoxysilane (51.7 mg, 0.423 mmol) were mixed, and the obtained solution was stirred at 40° C. for 18 hours. Thereafter, the solvent was distilled off to obtain 0.188 g of the following compound (A-3).

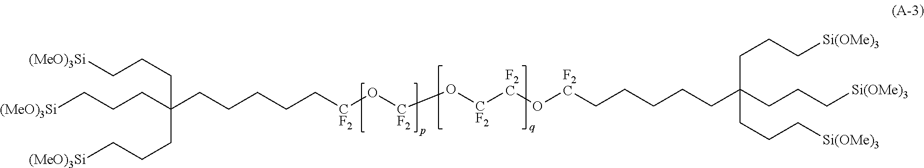

The average value of the number p of repeating units is 22, and the average value of q is 25.

### NMR Spectrum of Compound (A-3);

¹H-NMR (400 MHz, Chloroform-d) δ (ppm): 3.61 (s, 54H), 2.17 to 1.90 (m, 4H), 1.70 to 1.14 (m, 40H), 0.74 to 0.59 (m, 12H).

### Ex. 1

In a molybdenum boat in a vacuum vapor deposition apparatus (VTR-350M manufactured by ULVAC KIKO, Inc.), 30 g of silicon oxide (manufactured by Canon Optron, Inc.) as a vapor deposition material (vapor deposition source) and 0.11 g of compound (A-1) were placed. A glass substrate was placed in the vacuum vapor deposition apparatus, and the inside of the vacuum vapor deposition apparatus was evacuated until the pressure became at most 5×10⁻³ Pa.

The boat loaded with silicon oxide was heated to 2,000° C. to have vacuum vapor deposited on the glass substrate to form an undercoat layer having a thickness of 10 nm.

Further, a boat on which compound (A-1) was placed, was heated until it reached 700° C., and the compound (A-1) was vacuum vapor deposited on the surface of the undercoat layer to form a water and oil repellent layer with a thickness of 10 nm, followed by heat-treatment at 140° C. for 30 minutes. Thus, the substrate with the water and oil repellent layer of Ex. 1 was obtained.

### Ex. 2

A substrate with a water and oil repellent layer in Ex. 2 was obtained by carrying out the same procedure as in Ex. 1, except that as the vapor deposition material for the undercoat layer, a sintered material 1 obtained by the following procedure was used.

To an Eirich Intensive Mixer EL-1 (manufactured by Nippon Eirich Co., Ltd., hereinafter referred to as “EL 1”), 2.5 g of soda ash (manufactured by Soda Ash Japan Co., Ltd.) and 250 g of silica particles SC5500-SQ (trade name, manufactured by ADMATECHS COMPANY LIMITED) were added and stirred and mixed at 2,400 rpm for 30 seconds. The stirring speed was changed to 4,800 rpm, and while stirring, 40.2 g of distilled water was added, and further stirred at 4,800 rpm for 60 seconds. Finally, the mixture was stirred at 1,200 rpm for 60 seconds. The obtained particles were taken out from EL-1, dried at 150° C. for 30 minutes, and then sintered at 1,150° C. for 1 hour to obtain a sintered material 1.

### Ex. 3

A sintered material 2 was obtained by carrying out the same procedure as in Ex. 2, by setting the amount of soda ash (manufactured by Soda Ash Japan Co., Ltd.) added to be 7.5 g, and the amount of silica particles SC5500-SQ (trade name, manufactured by ADMATECHS COMPANY LIMITED) added to be 250 g. By carrying out the same procedure as in Ex. 1 except that the sintered material 2 was used, a substrate with a water and oil repellent layer in Ex. 3 was obtained.

### Ex. 4

A sintered material 3 was obtained by carrying out the same procedure as in Ex. 2, by setting the amount of soda ash (manufactured by Soda Ash Japan Co., Ltd.) added to be 25 g, and the amount of silica particles SC5500-SQ (trade name, manufactured by ADMATECHS COMPANY LIMITED) added to be 250 g. By carrying out the same procedure as in Ex. 1 except that the sintered material 3 was used, a substrate with a water and oil repellent layer in Ex. 4 was obtained.

### Ex. 5

A sintered material 4 was obtained by carrying out the same procedure as in Ex. 2, by setting the amount of soda ash (manufactured by Soda Ash Japan Co., Ltd.) added to be 50 g, and the amount of silica particles SC5500-SQ (trade name, manufactured by ADMATECHS COMPANY LIMITED) added to be 250 g. By carrying out the same procedure as in Ex. 1 except that the sintered material 4 was used, a substrate with a water and oil repellent layer in Ex. 5 was obtained.

### Ex. 6

A substrate with a water and oil repellent layer in Ex. 6 was obtained by carrying out the same procedure as in Ex. 1 except that the sintered material 5 obtained in the following procedure was used as the vapor deposition material for the undercoat layer.

To EL-1, 7.5 g of magnesium oxide (manufactured by Wako Pure Chemical Industries, Ltd., MgO) and 250 g of silica particles SC5500-SQ (trade name, manufactured by ADMATECHS COMPANY LIMITED) were added, followed by stirring at 2,400 rpm for 30 seconds. The stirring speed was changed to 4,800 rpm, and while stirring, 40.2 g of distilled water was added, followed by further stirring at 4,800 rpm for 60 seconds. Finally, the mixture was stirred at 1,200 rpm for 60 seconds. The obtained particles were taken out from EL-1 and dried at 150° C. for 30 minutes and then sintered at 1,150° C. for 1 hour to obtain a sintered material 5.

### Ex. 7

A substrate with a water and oil repellent layer in Ex. 7 was obtained by carrying out the same procedure as in Ex. 1 except that the sintered material 6 obtained in the following procedure was used as the vapor deposition material for the undercoat layer.

To EL-1, 7.5 g of boric acid particles (Optibor: product name, manufactured by HAYAKAWA & CO., LTD.) and 250 g of silica particles SC5500-SQ (trade name, manufactured by ADMATECHS COMPANY LIMITED) were added, followed by stirring at 2,400 rpm for 30 seconds. The stirring speed was changed to 4,800 rpm, and while stirring, 40.2 g of distilled water was added, followed by further stirring at 4,800 rpm for 60 seconds. Finally, the mixture was stirred at 1,200 rpm for 60 seconds. The obtained particles were taken out from EL-1 and dried at 150° C. for 30 minutes, and then sintered at 1,150° C. for 1 hour to obtain sintered material 6.

### Ex. 8

A substrate with a water and oil repellent layer of Ex. 8 was formed in the same manner as in Ex. 1, except that 0.12 g of compound (A-2) was placed as the vapor deposition material (vapor deposition source).

### Ex. 9

A substrate with a water and oil repellent layer of Ex. 9 was formed by using the sintered material 2 in the same manner as in Ex. 3, except that 0.15 g of compound (A-2) was placed as the vapor deposition material (vapor deposition source).

### Ex. 10

A substrate with a water and oil repellent layer in Ex. 10 was formed by using the sintered material 7 in the same manner as in Ex. 7, except that 0.15 g of compound (A-2) was placed as the vapor deposition material (vapor deposition source).

### Ex. 11

A substrate with a water and oil repellent layer of Ex. 11 was formed in the same manner as in Ex. 1, except that 0.16 g of compound (A-3) was placed as the vapor deposition material (vapor deposition source).

### Ex. 12

A substrate with a water and oil repellent layer of Ex. 12 was formed in the same manner as in Ex. 3, except that 0.14 g of compound (A-3) was placed as the vapor deposition material (vapor deposition source).

### [Physical Properties and Evaluations]

### (Content of Each Element in the Undercoat Layer)

By X-ray photoelectron spectroscopy (XPS) using C₆₀ ion sputtering, the depth direction profile of the molar concentration (mol %) of each element was obtained. Here, the molar concentration (mol %) of fluorine derived from the water and oil repellent layer to all elements detected by the XPS analysis was considered from the surface side of the depth direction profile of the substrate with a water and oil repellent layer, and the point at which the molar concentration of fluorine became to be at most 10 mol % was designated as the starting point A. Further, the point at which the molar concentration (mol %) of an optional element present only in the substrate to all elements detected by the XPS analysis exceeded 30% of the molar concentration (mol %) in the substrate for the first time was designated as the end point B. The area from the starting point A to the end point B was defined as the undercoat layer, and the ratio of the average value of the molar concentration (mol %) of the target element to the average value of the molar concentration (mol %) of silicon in the undercoat layer was calculated.

### <Apparatus>

X-Ray photoelectron spectrometer: ESCA-5500 manufactured by ULVAC-PHI, Inc.

### <Measurement Conditions>

X-Ray source: monochromatized AlKα ray

Photoelectron detection angle: 75 degrees to the sample surface

Pass energy: 117.4 eV

Step energy: 0.5 eV/step

Sputter ion: C₆₀ ions at an acceleration voltage of 10 kV

Sputter gun raster size: 3×3 mm²

Sputtering interval: 0.4 min

Sputtering rate of the thermal oxide film (SiO₂ film) on silicon wafer by sputter gun: 2.20 nm/min

Measurement pitch: 0.88 nm (in terms of the thermal oxide film on silicon wafer)

### <Measurement Method for Contact Angle>

The contact angle of approximately 2 μL of distilled water placed on the surface of the water and oil repellent layer was measured by using a contact angle measuring device (DM-500, manufactured by Kyowa Interface Science Co., Ltd.). Measurements were made at five different locations on the surface of the water and oil repellent layer, and the average value was calculated. The 29 method was used to calculate the contact angle.

### <Initial Contact Angle>

With respect to the water and oil repellent layer, the initial water contact angle was measured by the above-mentioned measurement method. The evaluation standards are as follows.

Initial water contact angle:

∘ (Excellent): at least 115 degrees.

Δ (Acceptable): at least 105 degrees and less than 115 degrees.

x (Not acceptable): less than 105 degrees.

### <Abrasion Resistance (Steel Wool)>

With respect to the water and oil repellent layers, using a reciprocating traverse tester (manufactured by KNT) in accordance with JIS L0849:2013 (ISO 105-X12: 2001), steel wool Bonster (#0000) was reciprocated 10,000 times under a pressure of 98.07 kPa at a speed of 320 cm/min, whereupon the water contact angle was measured. The smaller the decrease in water repellency (water contact angle) after abrasion, the smaller the decrease in performance due to abrasion and the better the abrasion resistance. The evaluation standards are as follows.

⊚ (Excellent): Change in water contact angle after 10,000 times of reciprocation is less than 1 degree.

◯ (Superior): Change in water contact angle after 10,000 times of reciprocation is at least 1 degree and less than 2 degrees.

□ (Good): Change in water contact angle after 10,000 times of reciprocation is at least 2 degrees and less than 3 degrees.

Δ (Acceptable): Change in water contact angle after 10,000 times of reciprocation is at least 3 degrees and less than 4 degrees.

x (Not acceptable): Change in water contact angle after 10,000 times of reciprocation is at least 4 degrees.

With respect to each of the above Examples, the above-described measurements of physical properties and evaluation tests were conducted. The evaluation results are shown in Table 1-1 and Table 1-2.

TABLE 1-1

| | | | | | | |
|---|---|---|---|---|---|---|
| Ex. | 1 | 2 | 3 | 4 | 5 | 6 |

Water and oil repellent layer

| | | | | | | |
|---|---|---|---|---|---|---|
| Compound | (A-1) | (A-1) | (A-1) | (A-1) | (A-1) | (A-1) |

Undercoat layer

| | | | | | | |
|---|---|---|---|---|---|---|
| Specific | — | Na | Na | Na | Na | Mg |
| element | | | | | | |
| Specific | Detectable | 0.01 | 0.43 | 1.60 | 2.92 | 0.43 |
| element/silicon | lower limit | | | | | |
| (molar ratio) | or less | | | | | |
| Initial contact | ◯ | ◯ | ◯ | ◯ | ◯ | ◯ |
| angle | | | | | | |
| Abrasion | X | ◯ | ⊚ | ⊚ | ◯ | ◯ |
| resistance | | | | | | |

TABLE 1-2

| | | | | | | |
|---|---|---|---|---|---|---|
| Ex. | 7 | 8 | 9 | 10 | 11 | 12 |

Water and oil repellent layer

| | | | | | | |
|---|---|---|---|---|---|---|
| Compound | (A-1) | (A-2) | (A-2) | (A-2) | (A-3) | (A-3) |

Undercoat layer

| | | | | | | |
|---|---|---|---|---|---|---|
| Specific | B | — | Na | B | — | Na |
| element | | | | | | |
| Specific | 0.41 | Detectable | 0.43 | 0.41 | Detectable | 0.43 |
| element/silicon | | lower limit | | | lower limit | |
| (molar ratio) | | or less | | | or less | |
| Initial contact | ◯ | ◯ | ◯ | ◯ | Δ | Δ |
| angle | | | | | | |
| Abrasion | □ | X | Δ | Δ | X | ⊚ |
| resistance | | | | | | |

As shown in Table 1, in each of Ex. 2 to 7 and 12 in which the undercoat layer contains a specific element and the water and oil repellent layer is made of a hydrolytic condensation product of compound (A1) (i.e. compound (A-I)) or compound (A2) (i.e. compound (A-3)), the initial water contact angle was at least acceptable and the abrasion resistance was at least good. In each of Ex. 1, 8 and 11 in which the undercoat layer does not contain the specific element, the abrasion resistance was not acceptable. In Ex. 9 and 10 in which the undercoat layer contains a specific element, but the water and oil repellent layer is formed by using a compound other than compound (A1) and compound (A2) (i.e. compound (A-2)), the abrasion resistance was acceptable and not adequate. In Ex. 2 to 6 and 12 in which the undercoat layer contains, as a specific element, Group 1 element (Na) and Group 2 element (Mg), the abrasion resistance was at least superior. In Ex. 3, 4 and 12 in which the undercoat layer contains, as a specific element, Group 1 element (Na) and the ratio of the total molar concentration of the specific element to the molar concentration of silicon in the undercoat layer is from 0.02 to 2.90, the abrasion resistance was excellent. In Ex. 2 to 7 in which the water and oil repellent layer is made of a hydrolytic condensation product of compound (A1), the initial water contact angle was excellent.

This application is a continuation of PCT Application No. PCT/JP2021/033352, filed on Sep. 10, 2021, which is based upon and claims the benefit of priority from Japanese Patent Application No. 2020-155248 filed on Sep. 16, 2020. The contents of those applications are incorporated herein by reference in their entireties.

### REFERENCE SYMBOLS

10: Substrate with water and oil repellent layer
12: Substrate
14: Undercoat layer
16: Water and oil repellent layer

1: A substrate with a water and oil repellent layer comprising;
a substrate,
an undercoat layer formed on a surface of the substrate, and
a water and oil repellent layer formed on a surface of the undercoat layer,
wherein
the undercoat layer contains an oxide containing silicon and at least one specific element selected from the group consisting of a Group 1 element, a Group 2 element, a Group 4 element, a Group 5 element, a Group 13 element, and a Group 15 element of the periodic table, and
the water and oil repellent layer is made of a hydrolytic condensation product of a fluorinated ether compound selected from the group consisting of a compound represented by formula (A1) and a compound represented by formula (A2):
R^{f}—O—(R^{f1}O)ₘ—R^{f2}[—R¹—C(—R²-T)ₐ(—R³)₃₋ₐ]_{b} (A1)
[(T-R²—)ₐ(R³—)₃₋ₐC—R¹—]_{b}R^{f2}—O—(R^{f1}O)ₘ—R^{f2}[—R¹—C(—R²-T)ₐ(—R³)₃₋ₐ]_{b} (A2)
where
m is an integer of from 1 to 20,
a is an integer of from 1 to 3; and if a plurality of a is present, the plurality of a may be the same or different,
b is an integer of 1 or more; if a plurality of b is present, the plurality of b may be the same or different; and if b is 1, a is 2 or 3,
R^{f} is a C₁₋₂₀ fluoroalkyl group,
R^{f1} is a C₁₋₆ fluoroalkylene group,
R²² is a (1+b)-valent hydrocarbon group having one or more fluorine atoms, at least one carbon atom bonded to R¹ in R^{f2} having the one or more fluorine atoms, and if a plurality of R^{f2} is present, the plurality of R^{f2} may be the same or different,
R¹ is a C₁₋₂₀ alkylene group,
each R² is independently a C₂₋₂₀ alkylene group which may have one or more fluorine atoms,
R³ is a hydrogen atom or a C₁₋₁₀ alkyl group which may have one or more fluorine atoms, and if a plurality of R³ is present, the plurality of R³ may be the same or different, and
each T is independently —Si(R)_{3-c}(L)_{c}, where c is 2 or 3 and the plurality of c may be the same or different, R is an alkyl group, and each L is independently a hydrolysable group or a hydroxy group.

2: The substrate with a water and oil repellent layer according to claim 1, wherein R^{f2} is a hydrocarbon group having b substructures represented by formula -CQF-*, where Q is a hydrogen atom, a fluorine atom, or CF₃, and -* is a bond to R¹.

3: The substrate with a water and oil repellent layer according to claim 1, wherein b is 1, and R^{f2} is a C₁₋₆ perfluoroalkylene group.

4: The substrate with a water and oil repellent layer according to claim 1, wherein the specific element is at least one selected from the group consisting of a Group 1 element, a Group 2 element, and a Group 13 element of the periodic table.

5: The substrate with a water and oil repellent layer according to claim 1, wherein the specific element is a Group 1 element of the periodic table.

6: The substrate with a water and oil repellent layer according to claim 1, wherein b is 1.

7: The substrate with a water and oil repellent layer according to claim 1, wherein a is 3.

8: The substrate with a water and oil repellent layer according to claim 1, wherein a ratio of a total molar concentration of the specific element to a molar concentration of silicon in the undercoat layer is from 0.02 to 2.90.

9: A method for producing a substrate with a water and oil repellent layer, having a substrate, an undercoat layer, and a water and oil repellent layer in this order, the method comprising:
forming, on said substrate, an undercoat layer containing an oxide containing silicon and at least one specific element selected from the group consisting of a Group 1 element, a Group 2 element, a Group 4 element, a Group 5 element, a Group 13 element, and a Group 15 element of the periodic table, and
then, forming, on the undercoat layer, a water and oil repellent layer made of a hydrolytic condensation product of a fluorinated ether compound selected from the group consisting of a compound represented by formula (A1) and a compound represented by formula (A2):
R^{f}—O—(R^{f1}O)ₘ—R^{f2}[—R¹—C(—R²-T)ₐ(—R³)₃₋ₐ]_{b} (A1)
[(T-R²—)ₐ(R³—)₃₋ₐC—R¹—]_{b}R^{f2}—O—(R^{f1}O)ₘ—R^{f2}[—R¹—C(—R²-T)ₐ(—R³)₃₋ₐ]_{b} (A2)
where
m is an integer of from 1 to 20,
a is an integer of from 1 to 3; and if a plurality of a is present, the plurality of a may be the same or different,
b is an integer of 1 or more; if a plurality of b is present, the plurality of b may be the same or different; and if b is 1, a is 2 or 3,
R^{f} is a C₁₋₂₀ fluoroalkyl group,
R^{f1} is a C₁₋₆ fluoroalkylene group,
R^{f2} is a (1+b)-valent hydrocarbon group having one or more fluorine atoms, at least one carbon atom bonded to R¹ in R^{f2} having the one or more fluorine atoms, and if a plurality of R^{f2} is present, the plurality of R^{f2} may be the same or different,
R¹ is a C₁₋₂₀ alkylene group,
each R² is independently a C₂₋₂₀ alkylene group which may have one or more fluorine atoms,
R³ is a hydrogen atom or a C₁₋₁₀ alkyl group which may have one or more fluorine atoms, and if a plurality of R³ is present, the plurality of R³ may be the same or different, and
each T is independently —Si(R)_{3-c}(L)_{c}, where c is 2 or 3 and the plurality of c may be the same or different, R is an alkyl group, and each L is independently a hydrolysable group or a hydroxy group.

10: The method according to claim 9, wherein R² is a hydrocarbon group having b substructures represented by formula -CQF-*, where Q is a hydrogen atom, a fluorine atom, or CF₃, and -* is a bond to R¹.

11: The method according to claim 9, wherein b is 1, and R^{f2} is a C₁₋₆ perfluoroalkylene group.

12: An optical member, comprising:
the substrate with a water and oil repellent layer according to claim 1.
